(19) United States
(12) Patent Application Publication
(10) Pub. No.: US 2026/0161134 A1
(43) Pub. Date: Jun. 11, 2026

(54) ASSEMBLY OF TWO MICROMECHANICAL PARTS

(71) Applicant: ETA SA MANUFACTURE HORLOGÈRE SUISSE, Grenchen (CH)

(72) Inventors: Joël ROTHLISBERGER, Grenchen (CH); Patric PHAM, Utzenstorf (CH)

(73) Assignee: ETA SA MANUFACTURE HORLOGÈRE SUISSE, Grenchen (CH)

(21) Appl. No.: 19/393,816

(22) Filed: Nov. 19, 2025

(30) Foreign Application Priority Data
Dec. 11, 2024 (EP) 24219096.5

(51) Int. Cl. G04B 1/16

(52) U.S. Cl. CPC G04B 1/16

(57) ABSTRACT

An assembly (10) including a first and a second micromechanical part (11, 20) engaging with each other, the first part (11) including a plate (12) from which extends a connecting member (13) formed by a protruding body having at least one radial shoulder (130) forming a surface of revolution, and at least one axial shoulder (131) formed by a radially extending shouldering (132) and generating an allowance on the plate (12), the connecting member (13) on the first part (11) engaging in a pivot connection with a complementary connecting member (21) on the second part so that the second part is pressed against the axial (131) and radial (130) shoulders.

### CROSS-REFERENCE TO RELATED APPLICATIONS

This application claims priority to European Patent Application No. 24219096.5, filed on Dec. 11, 2024, the entire contents of which are incorporated herein by reference.

### TECHNICAL FIELD OF THE INVENTION

The invention relates to the field of micromechanics and more specifically to that of horology.

More specifically, the invention relates to an assembly comprising a first and a second micromechanical parts.

### TECHNOLOGICAL BACKGROUND

In the horology field, when two assembled parts are designed to be pivoted relative to each other, they are arranged in contact with each other by a radial support and by an axial support.

In particular, in the case of a wheel 1 fastened so as to be rotationally mobile on an axis 2 of a mobile 3, the wheel 1 rests axially on a support formed on a plate 4 on a wheel or on a pinion on the mobile 3. This support is generally formed by an annular dimple 5, as can be seen in the cross-sectional view in FIG. 1. This type of design is often used, for example, to guide a date disc.

This annular dimple 5 can be machined by turning or by milling.

Milling can be done with a cutting tool that has a complementary shape to the annular dimple 5. In this case, the tool is moved downwards along an axis that runs through the centre of the annular dimple 5.

The drawback with this type of machining is that it requires a specific tool for each part with a different dimension or for each different dimple profile.

The annular dimple 5 can also be produced by milling with a conventional cutting tool. However, when this operation is possible, it can be complicated, as the distance between the annular dimple 5 and the axis 2 of the mobile 3 defines the maximum diameter of the cutting tool and this dimension can be extremely small, for example on the order of a tenth of a millimetre.

In any case, irrespective of the method used to manufacture this annular dimple 5, due to the dimple's very small dimensions and shape, it is time-consuming and expensive to use.

There is thus a need to design an assembly for which the parts are easier to manufacture.

### SUMMARY OF THE INVENTION

The invention remedies the aforementioned drawbacks and, to this end, it relates to an assembly comprising a first and a second micromechanical part engaging with each other. The first part comprises a plate from which extends a connecting member formed by a protruding body comprising at least one radial shoulder forming a surface of revolution, and at least one axial shoulder formed by a radially extending shouldering and generating an allowance on the plate.

The connecting member on the first part engages in a pivot connection with a complementary connecting member on the second part so that the second part is pressed against the axial and radial shoulders.

Because of these characteristics, the parts in the assembly are relatively easy to machine using conventional cutting tools.

In particular embodiments, the invention can further comprise one or more of the following features, taken separately or in any technically possible combination.

In particular embodiments, the connecting member comprises at least one axial groove for reducing the contact surface between the first and second parts and extending between a distal end opening onto a free end of the connecting member and a proximal end opening onto the or one of the axial shoulders.

In particular embodiments, the connecting member comprises at least three radial shoulders separated from each other by evenly spaced grooves so that the radial shoulders extend over an angular sector substantially identical to each other.

In particular embodiments, the radial shoulder or one of the radial shoulders is elastically distortable in a radial direction, said radial shoulder being distorted when the connecting member engages the complementary connecting member on the second part.

In particular embodiments, the distortable radial shoulder is formed by a resilient blade extending in a curvilinear direction.

In particular embodiments, the resilient blade is configured so as to radially extend beyond the surface of revolution.

### BRIEF DESCRIPTION OF THE FIGURES

Other features and advantages of the invention will become apparent from the following detailed description, given by way of non-limiting example, with reference to the attached drawings in which:

FIG. 1 shows a perspective view of a wheel rotationally fastened on an axis of a mobile according to a design from the prior art,

FIG. 2 shows a perspective close-up view of a connecting member on a first part in an assembly of micromechanical parts according an exemplary embodiment of the invention,

FIG. 3 schematically shows a cross-sectional view of the first part in FIG. 2 engaging with a second part so as to form an assembly according to an exemplary embodiment of the invention,

FIGS. 4 and 5 show a perspective view of the first part in FIG. 2 according to other exemplary embodiments of the invention.

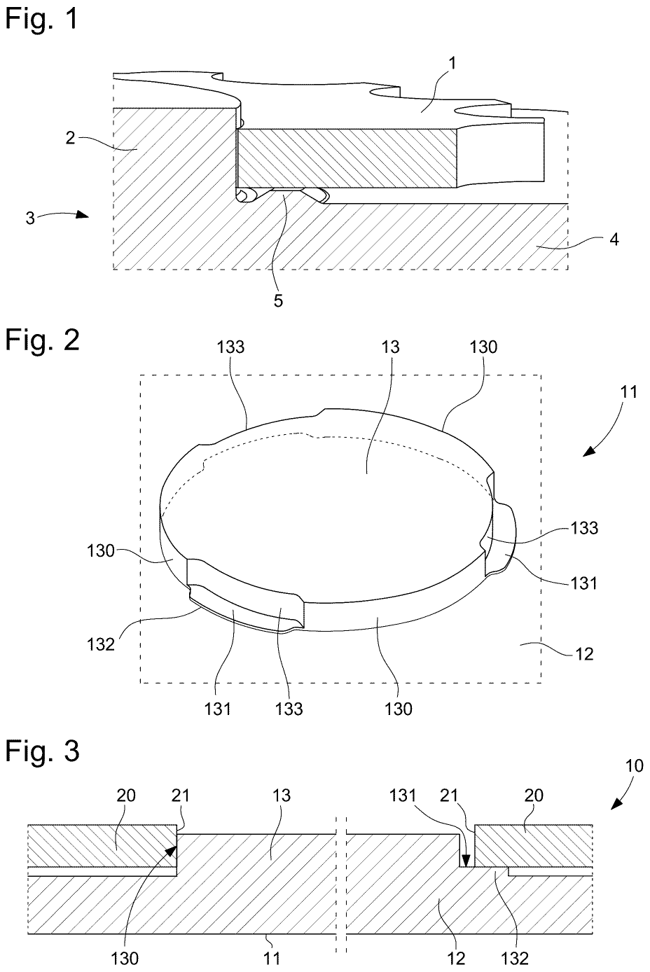

It should be noted that the figures are not necessarily drawn to scale for clarity reasons.

### DETAILED DESCRIPTION OF THE INVENTION

The present invention relates to an assembly 10 comprising a first and a second micromechanical part 11 and 20 engaging with each other via a connecting pivot.

FIG. 2 shows a first part 11 of the assembly 10 in a first exemplary embodiment of the invention. The assembly 10 is shown in cross-sectional view in FIG. 3.

This first part 11 comprises a plate 12 from which a connecting member 13 formed by a protruding body extends and with which a complementary connecting member 21 on the second part 20 engages when the first and second parts 11 and 20 are assembled.

The connecting member 13 can be in the form of an arbor, a rod, a stud, a pin or any other protruding shape. The connecting member 13 comprises at least one radial shoulder 130 defining a surface of revolution, and at least one axial shoulder 131 formed by a radially extending shouldering 132 and generating an allowance on the plate 12, as can be seen in FIG. 3.

The surface of revolution formed by the radial shoulder 130 is preferentially in the shape of a straight cylinder, but can alternatively be of any other geometric shape.

The connecting member 13 on the first part 11 is configured so that when it engages with the complementary connecting member 21 on the second part, the second part presses against the radial 130 and axial 131 shoulders.

Advantageously, the connecting member 13 can comprise at least one axial groove 133, such as a flute, for reducing the contact surface between the connecting member 13 and the second part 20. Such a groove 133 has a distal end opening onto a free end of the connecting member 13, namely, its top, and a proximal end at the base of the connecting member opening onto the or one of the axial shoulders 131. In particular, as shown in FIGS. 2, 4 and 5, the or each axial shoulder 131 extends over an angular sector corresponding at most to the width of a groove 133, so that the or each axial shoulder 131 extends only facing a groove 133. Thus, the axial shoulder(s) 131 and the radial shoulder or shoulders 130 extend along strictly different angular sectors, which makes it possible to keep the second part 20 from pressing against a neck moulding machined at the base of the radial shoulder or shoulders 130 when the connecting member 13 is formed, and consequently to avoid any uncertainty in the position of the second part 20.

The groove or grooves 133 further reduce the risk of the second part 20 bowing.

In the exemplary embodiment of the invention shown in FIG. 2, the connecting member 13 comprises three radial shoulders 130 separated from each other by a groove 133. The grooves 133 are, for example, evenly spaced around the connecting member 13 so that the radial shoulders 130 extend over an angular sector, for example, identical to each other. Advantageously, the mechanical connection is isostatic.

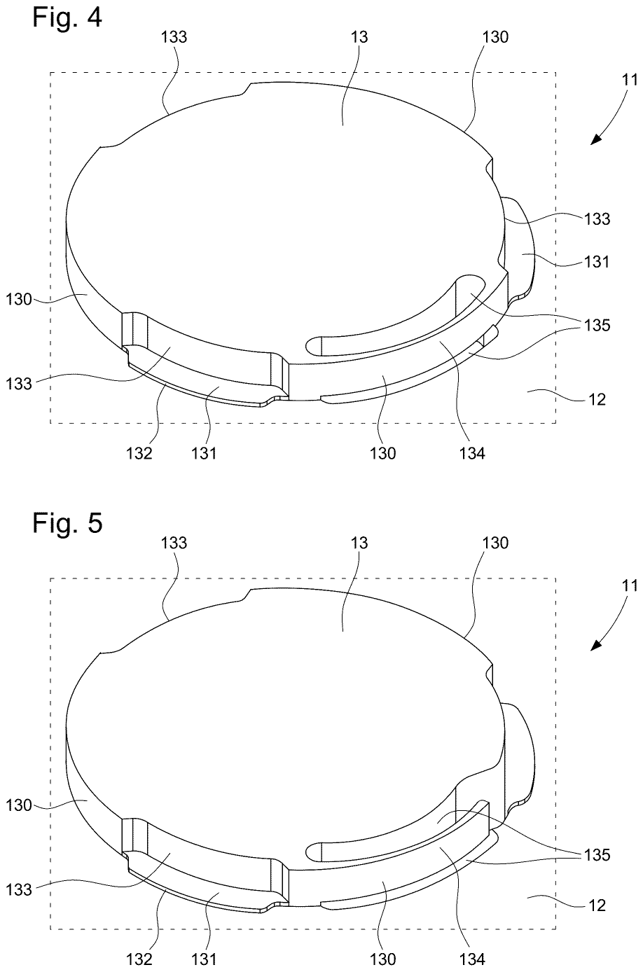

Advantageously, as can be seen in the exemplary embodiments in FIGS. 4 and 5, the connecting member 13 can be configured so that at least one of the radial shoulders 130 can be elastically distorted in a radial direction. The distortable radial shoulder 130 is designed to distort when the connecting member 13 engages with the complementary connecting member 21 on the second part 20, so as to further control the mechanical slack between the connecting member 13 and the complementary connecting member 21.

The distortable radial shoulder 130 is preferentially formed by a resilient blade 134, as can be seen in FIG. 4. This resilient blade 134 comprises two longitudinal ends by which it is connected to the connecting member 13. Alternatively, as can be seen in FIG. 5, the resilient blade 134 can be connected to the connecting member 13 by one end only, its other end then being free. In these two exemplary embodiments, the resilient blade 134 extends in a curvilinear direction preferentially centred on the axis of revolution of the surface of revolution formed by the radial shoulders 130.

It can also be foreseen that the resilient blade 134 is configured so as to radially extend beyond the surface of revolution formed by the radial shoulders 130. In this case, the second part 20 has one or more radial notches, for example formed by a toothing, that can engage with the blade so as to form a click or any other angular position indexing mechanism.

The resilient blade 134 is produced by machining an opening 135 in the connecting member 13 and in the plate 12, as can be seen in FIGS. 4 and 5.

Given the characteristics of the invention, manufacturing the first part 11, and in particular machining the connecting member 13, is particularly easy to do, as machining can be carried out with a single conventional cutting tool, such as a double-edge milling cutter.

More generally, it should be noted that the embodiments and uses considered above have been described by way of non-limiting examples, and that other variants are therefore conceivable.

In particular, in FIGS. 2 to 5, the connecting member 13 is shown as having radial shoulders 130 on its outer periphery and the complementary connecting member 21 is shown in FIG. 3 pressing against the radial shoulders 130 on its inner periphery, but it can be foreseen that the radial shoulders 130 are arranged on an inner periphery of the connecting member 13 and that the complementary connecting member 21 presses against the radial shoulders 130 on its outer periphery.

The connecting member 13 can thus be formed by a cavity in which the complementary connecting member 21, formed by a protruding body such as an arbor, a rod, a pin, a stud, etc., is engaged.

1. An assembly comprising a first and a second micromechanical part engaging with each other, wherein the first part comprises a plate from which extends a connecting member formed by a protruding body comprising at least one radial shoulder forming a surface of revolution, and at least one axial shoulder formed by a radially extending shouldering and generating an allowance on the plate, the connecting member on the first part engaging in a pivot connection with a complementary connecting member on the second part so that the second part is pressed against the axial and radial shoulders, the connecting member comprising at least one axial groove for reducing the contact surface between the first and second parts and extending between a distal end opening onto a free end of the connecting member and a proximal end opening onto the or one of the axial shoulders.

2. The assembly according to claim 1, wherein the connecting member comprises at least three radial shoulders separated from each other by evenly spaced grooves so that the radial shoulders extend over an angular sector substantially identical to each other.

3. The assembly according to claim 1, wherein the radial shoulder or one of the radial shoulders is elastically distortable in a radial direction, said radial shoulder being distorted when the connecting member engages the complementary connecting member on the second part.

4. The assembly according to claim 1, wherein the distortable radial shoulder is formed by a resilient blade extending in a curvilinear direction.

5. The assembly according to claim 4, wherein the resilient blade is configured so as to radially extend beyond the surface of revolution.
